(19) United States
(12) Patent Application Publication
(10) Pub. No.: US 2014/0119512 A1
(43) Pub. Date: May 1, 2014

(54) X-RAY DETECTOR AND X-RAY DIFFRACTION DEVICE

(71) Applicant: RIGAKU CORPORATION, Tokyo (JP)

(72) Inventors: Kazuyuki Matsushita, Tokyo (JP); Masaru Kuribayashi, Tokyo (JP)

(73) Assignee: RIGAKU CORPORATION, Tokyo (JP)

(21) Appl. No.: 14/034,031

(22) Filed: Sep. 23, 2013

(30) Foreign Application Priority Data
Oct. 31, 2012 (JP) 2012-240040

(51) Int. Cl. G01N 23/207; G01T 1/16

(52) U.S. Cl. CPC G01N 23/207; G01T 1/16
USPC 378/81; 250/394

(57) ABSTRACT

A silicon strip detector having a first X-ray detection unit having plural strips arranged in parallel to one another in a first direction, and a second X-ray detection unit having plural strips arranged in parallel to one another in a second direction orthogonal to the first direction is used as an X-ray detector. The X-ray detector is mounted in an X-ray diffraction device while the first direction is matched with the tangential direction of 2θ-rotation, and the second direction is matched with the tangential direction of χ-rotation for executing in-plane diffraction measurement.

### FIELD OF THE INVENTION

The present invention relates to an X-ray diffraction device in which both of normal X-ray diffraction measurement based on 2θ-rotation and in-plane diffraction measurement can be performed, and an X-ray detector suitable for the X-ray diffraction device.

### BACKGROUND OF THE INVENTION

A Silicon Strip Detector (SSD) is known as an X-ray detector applicable to X-ray diffraction measurement. As shown in FIG. 8, a conventional silicon strip detector is configured so that strip-shaped p⁺-type semiconductors are formed on the surface of an n-type semiconductor and an n⁺-type semiconductor is disposed at the back surface side of the n-type semiconductor, for example. A sufficient inverse bias voltage is applied between each p⁺-type semiconductor and the n⁺-type semiconductor to generate a depletion layer in an n-type semiconductor surface portion. Accordingly, each strip-shaped p⁺-type semiconductor and the n-type semiconductor form p-n junction, whereby each strip functions as a semiconductor detector. When charged particles pass through the thus-formed depletion layer, electron and hole pairs whose number is proportional to the energy released from the charged particles occur, and the electrons are attracted to the strip-shaped p⁺-type semiconductor (hereinafter referred to as “p+ strip”) while the holes are attracted to the n⁺-type semiconductor surface. Accordingly, by reading these signals, the positions at which the charged particles pass and the energy released from these charged particles to the detectors (i.e., p⁺ strips) can be detected. An n⁺-type semiconductor may be used as a strip for reading these signals (see pages 26 to 27 of “Research & Development of Extended Interval Silicon Strip Detector in BELLE-SVD”, Treatise of Senyo Katsumi, Nagashima's Laboratory, Department of Physics, Faculty of Science of Osaka University, Feb. 8, 1996 (Document 5).

FIG. 9 is a diagram showing the construction of an X-ray detector to which a silicon strip detector disclosed in JP-A-2010-38722 (Document 1) is applied.

The X-ray detector 102 has plural slender unit detection areas 103. The unit detection areas 103 extend so as to be elongated in an X-direction. These unit detection areas 103 are arranged in parallel to one another (i.e., arranged side by side). That is, the plural unit detection areas 103 are arranged to be adjacent to one another along a Y-direction (a direction perpendicular to the X-direction). This X-ray detector 102 is a one-dimensional position sensitive type detector that can discriminate (identify) the detection position in the Y-direction.

Each unit detection area 103 is connected to a detection circuit 101. The unit detection area 103 has a function of detecting X-ray photons one by one, and outputs an electrical signal corresponding to the energy of detected X-ray. The detection circuit 101 takes (detects) only signals corresponding to X-ray energy between predetermined upper and lower limit energy values out of signals output from the unit detection areas 103 by the energy discriminating function thereof. That is, the detection circuit 101 counts only the signals as described above. The upper and lower limit energy values of the X-ray energy may be arbitrarily set by an operator.

Some X-ray diffraction devices can perform both of X-ray diffraction measurement based on 2θ-rotation and in-plane diffraction measurement. JP-A-H11-304731 (Document 2) and JP-A-2004-294136 (Document 3) disclose this type of X-ray diffraction devices.

Here, the in-plane diffraction is a phenomenon that when X-ray is incident to the surface of a sample at a minute incident angle, diffraction X-ray occurs at a minute angle with respect to the surface of the sample. This phenomenon is based on a phenomenon that when X-ray is incident to a sample at a minute incident angle, an X-ray component traveling in parallel to the surface of the sample appears in the sample, and diffraction of the X-ray component occurs at a crystal plane perpendicular to the surface of the sample, so that the diffraction X-ray thereof is radiated from the sample nearly in parallel to the surface of the sample.

This in-plane diffraction is a method suitable for estimation of thin film, and it is very useful to estimation of samples such as a sample whose film thickness decreases, a sample in which in-plane orientation appears due to compatibility with a substrate, etc. In order to perform the in-plane diffraction measurement, the X-ray detector must be subjected to 2θ-rotation for optical position adjustment, and also must be subjected to scan-rotation in an in-plane direction perpendicular to the 2θ-rotation plane, that is, in a χ-direction to detect in-plane diffraction X-ray.

In a case where the X-ray detector (silicon strip detector) described above is applied to the X-ray diffraction device as described above, the arrangement direction of the unit detection areas 103 is required to be matched (coincident) with the tangential direction of the 2θ-rotation when the X-ray diffraction measurement based on the 2θ-rotation is performed as shown in FIG. 10. Furthermore, the arrangement direction of the unit detection areas 103 is required to be matched (coincident) with the tangential direction of the χ-rotation corresponding to the in-plane scan direction when the in-plane diffraction measurement is performed as shown in FIG. 11.

Accordingly, when the X-ray detector 102 which is configured so that plural slender unit detection areas 103 are arranged in parallel to one another like the silicon strip detector is applied to the conventional X-ray diffraction device, the arrangement (orientation) of the X-ray detector 102 must be changed between the X-ray diffraction measurement based on 2θ-rotation and the in-plane diffraction measurement every time, and this changing work is cumbersome and disturbs quick measurement.

U.S. Patent Publication No. 2005-0105684 (Document 4) discloses a construction for rotating an X-ray detector around an axis perpendicular to a detection plane. However, the disclosed construction is merely conceptual, and when it is applied to an actual device, incorporation of a rotating mechanism into an X-ray detector makes the X-ray detector remarkably larger in size because the X-ray detector itself is originally large in size and heavy in weight. Therefore, there may occur such a problem that the scan range of the X-ray detector must be restricted to avoid interference with surrounding constituent elements.

### SUMMARY OF THE INVENTION

The present invention has been implemented in view of the foregoing situation, and has an object to provide an X-ray detector that is suitable for an X-ray diffraction device and has plural slender unit measurement areas arranged in parallel to one another so that both of X-ray diffraction measurement based on 2θ-rotation and in-plane diffraction measurement can be performed, and an X-ray diffraction device to which the X-ray detector is applied.

In order to attain the above object, according to a first aspect of the present invention, an X-ray detector comprises a first X-ray detection unit having a plurality of slender unit measurement areas arranged in parallel to one another in a first direction, and a second X-ray detection unit having a plurality of slender unit measurement areas arranged in parallel to one another in a second direction orthogonal to the first direction.

The X-ray detector is a one-dimensional position sensitive type detector that can discriminate (identify) the detection position in a direction along which the plural slender unit measurement areas are arranged in parallel to one another.

The X-ray detector may be constructed by a silicon strip detector in which strips formed of semiconductor form the slender unit measurement areas.

Furthermore, according to a second aspect of the present invention, in an X-ray diffraction device comprising a θ-rotation mechanism that rotates a sample held in a sample holder around an ω axial line passing on the surface of the sample, an X-ray source that irradiates the surface of the sample with X-ray, an X-ray detector that detects X-ray diffracted from the sample, a 2θ-rotation mechanism that subjects the X-ray detector to 2θ-rotation around the ω axial line, and an in-plane rotation mechanism that subjects the X-ray detector to χ-rotation around an axial line orthogonal to the ω axial line, the X-ray detector comprises the X-ray detector according to the first aspect of the present invention.

Here, in the X-ray detector, the first direction along which the slender unit measurement areas of the first X-ray detection unit are arranged in parallel to one another is matched with the tangential direction of the 2θ-rotation, and the second direction along which the slender unit measurement areas of the second X-ray detection unit are arranged in parallel to one another is matched with the tangential direction of the χ-rotation.

According to the above construction, the X-ray detection based on 2θ-rotation can be performed by the first X-ray detection unit, and the X-ray detection based on χ-rotation can be performed by the second X-ray detection unit. Accordingly, both of the X-ray diffraction measurement based on 2θ-rotation and the in-plane diffraction measurement based on χ-rotation can be easily and rapidly performed without exchanging the X-ray detector and without providing any rotating mechanism for the X-ray detector itself.

Furthermore, the X-ray diffraction device further comprises a selecting and operating unit that selects and operates any one of the first X-ray detection unit and the second X-ray detection unit.

Still furthermore, the X-ray diffraction device further comprises a data processing unit that processes detection data output from any one of the first X-ray detection unit and the second X-ray detection unit, and the selecting and operating unit automatically selects and operates one of the first X-ray detection unit and the second X-ray detection unit whose detection data is selected as a data processing target by the data processing unit.

In the X-ray detector, the first X-ray detection unit and the second X-ray detection unit are arranged separately from each other, and thus the measurement reference positions thereof are away from each other. Accordingly, when the X-ray diffraction device is controlled, it is necessary that the origin for 2θ-rotation is associated (matched) with the X-ray measurement reference position of the first X-ray detection unit and also the origin for χ-rotation is associated (matched) with the X-ray measurement reference position of the second X-ray detection unit.

Therefore, the present invention is preferably provided with an origin matching unit that matches a predetermined X-ray measurement reference position of the first X-ray detection unit with a measurement origin for the 2θ-rotation and matches a predetermined X-ray measurement reference position of the second X-ray detection unit with a measurement origin for the χ-rotation on the basis of the predetermined X-ray measurement reference position of the first X-ray detection unit and the predetermined X-ray measurement reference position of the second X-ray detection unit.

Furthermore, the present invention may be provided with an origin matching unit that matches a predetermined X-ray measurement reference position of the first X-ray detection unit with a measurement origin for the 2θ-rotation on the basis of the predetermined X-ray measurement reference position of the first X-ray detection, and an origin correcting unit that corrects a displacement between a predetermined X-ray measurement reference position of the second X-ray detection unit and a measurement origin for the χ-rotation on the basis of the predetermined X-ray measurement reference position of the second X-ray detection unit, the displacement occurring under a state that the X-ray measurement reference position of the first X-ray detection unit is matched with the measurement origin for the 2θ-rotation. Or, the present invention may be provided with an origin matching unit that matches a predetermined X-ray measurement reference position of the second X-ray detection unit with a measurement origin for χ-rotation on the basis of the predetermined X-ray measurement reference position of the second X-ray detection unit, and an origin correcting unit that corrects a displacement between a predetermined X-ray measurement reference position of the first X-ray detection unit and a measurement origin for the 2θ-rotation on the basis of the predetermined X-ray measurement reference position of the first X-ray detection unit, the displacement occurring under a state that the X-ray measurement reference position of the second X-ray detection unit is matched with the measurement origin for the χ-rotation.

In the above construction, the first X-ray detection unit and the second X-ray detection unit may be formed integrally with each other on the same substrate.

Furthermore, the X-ray diffraction device may be configured so that two element X-ray detectors each having a plurality of slender unit measurement areas arranged in parallel to one another are arranged on the same substrate, the plurality of slender unit measurement areas of one of the element X-ray detectors are arranged in the first direction to constitute the first X-ray detection unit, and the plurality of slender unit measurement areas of the other element X-ray detector are arranged in the second direction to constitute the second X-ray detection unit.

In the above construction, a flat-plate type shield cover that has an X-ray shielding function and is provided with a linear slit formed therein may be mounted on a detection face of the second X-ray detection unit while the longitudinal direction of the slit is matched with the second direction.

With the above construction, the plural unit measurement areas of the second X-ray detection unit are converted to only spot-shaped measurement areas which confront the slit. That is, plural spot-shaped measurement areas as described above are set to be arranged in parallel to one another in the second direction. The X-ray data detected at each spot-shaped measurement area is accumulated in association with the slit position at the detection time point while the X-ray detector is scanned (2θ-scanned) in the direction (2θ-rotation direction) orthogonal to the parallel arrangement direction, whereby two-dimensional X-ray diffraction data based on coordinate axes corresponding to the two directions of the parallel arrangement direction of the measurement areas and the scan direction orthogonal to the parallel arrangement direction can be obtained (in this specification, this measurement method is referred to as “pseudo two-dimensional measurement”).

As described above, according to the present invention, both of the X-ray diffraction measurement based on 2θ-rotation and the in-plane diffraction measurement based on χ-rotation can be easily and quickly performed without exchanging the X-ray detector and without providing any rotating mechanism for the X-ray detector itself.

### BRIEF DESCRIPTION OF THE DRAWINGS

FIG. 1 is a plan view showing an X-ray detector according to an embodiment of the present invention;

FIG. 2 is a schematic diagram showing an X-ray diffraction device according to the embodiment of the present invention;

FIG. 3 is a diagram showing the measurement principle based on a TDI mode;

FIG. 4 is a block diagram showing a control/processing system of the X-ray diffraction device according to the embodiment of the present invention;

FIGS. 5A to 5D are diagrams showing an origin matching unit and an origin correcting unit;

FIG. 6 is a plan view showing the construction for the X-ray detector to execute pseudo two-dimensional measurement;

FIG. 7 is a plan view showing an X-ray detector according to another embodiment of the present invention;

FIG. 8 is a perspective view showing the construction of a silicon strip detector;

FIG. 9 is a plan view showing the construction of the silicon strip detector;

FIG. 10 is a schematic diagram showing a prior art in which a silicon strip detector is applied to X-ray diffraction measurement based on 2θ-rotation; and

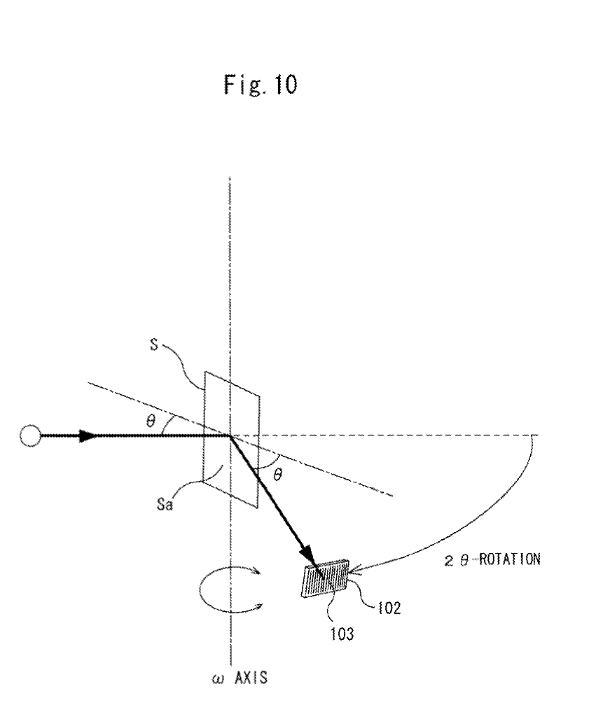

FIG. 11 is a schematic diagram showing a prior art in which a silicon strip detector is applied to in-plane diffraction measurement.

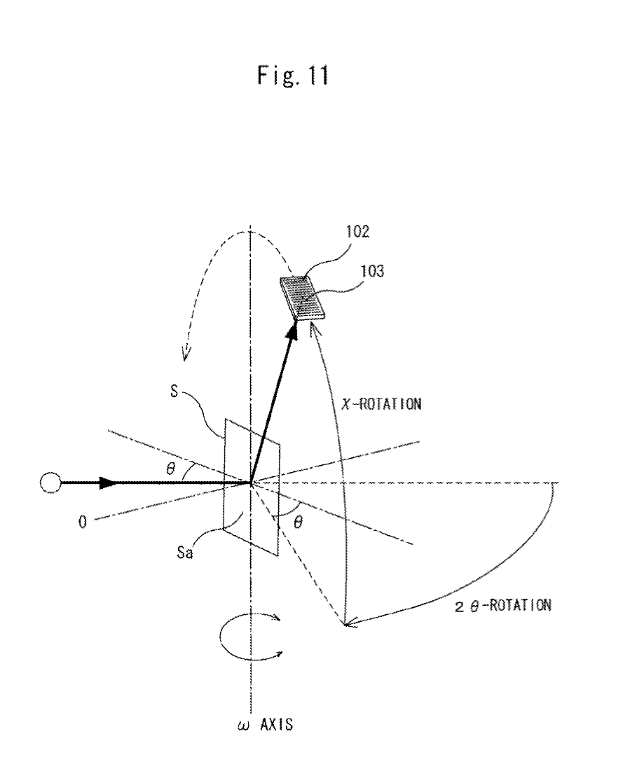

### DETAILED DESCRIPTION OF THE EMBODIMENTS

Embodiments according to the present invention will be described hereunder with reference to the drawings.

### [Construction of X-Ray Detector]

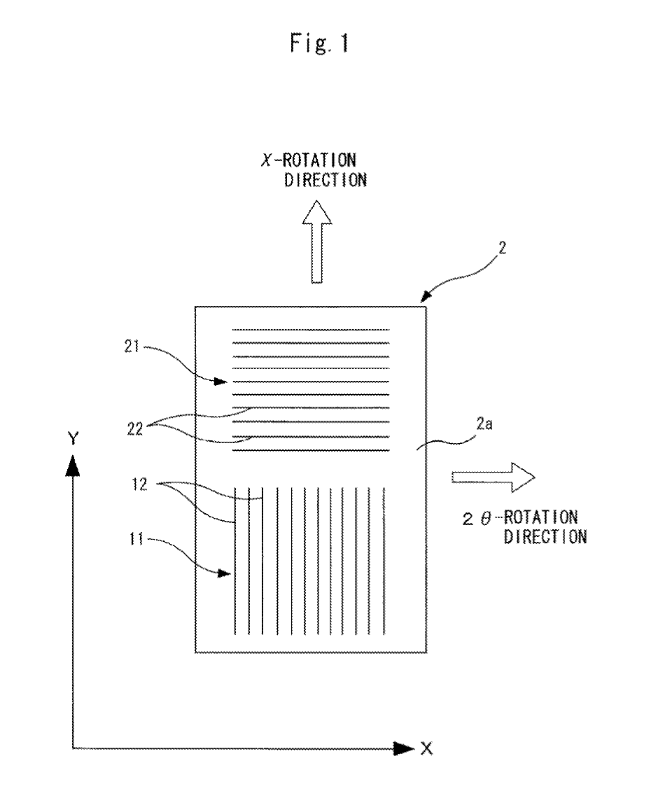

First, the construction of an X-ray detector according to an embodiment of the present invention will be described with reference to FIG. 1.

The X-ray detector 2 shown in FIG. 1 has a first X-ray detection unit 11 having plural strips 12 which form slender unit measurement areas and are arranged in parallel to one another (side by side) in an X-direction (first direction), and a second X-ray detection unit 21 having plural strips 22 which form slender unit measurement areas and are arranged in parallel to one another (side by side) in a Y-direction (second direction) like the first X-ray detection unit 11. Here, the X-direction (first direction) and the Y-direction (second direction) are orthogonal to each other.

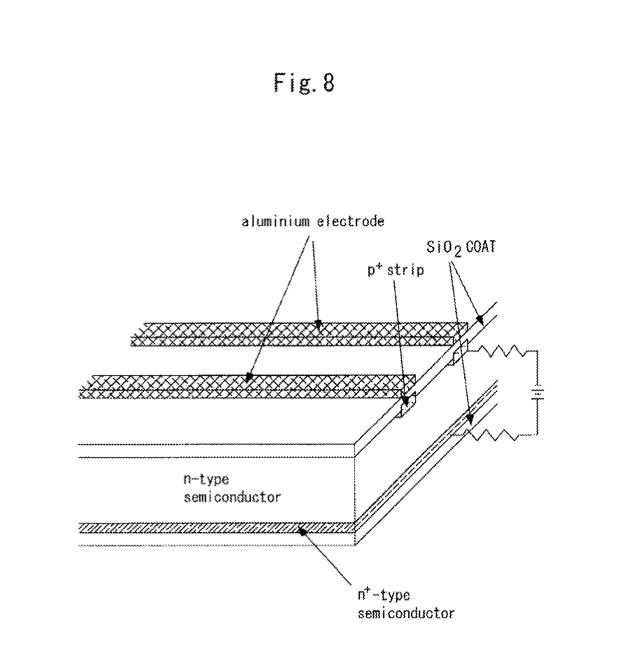

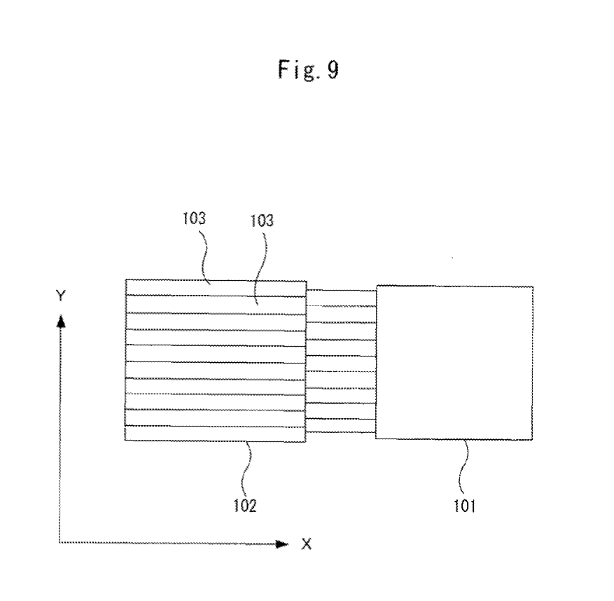

The X-ray detector of this embodiment is configured by applying the silicon strip detector as shown in FIGS. 8 and 9, and each of the strips 12 and 22 forming the slender unit measurement areas are formed of semiconductor. Specifically, strips 12, 22 formed of p⁺-type semiconductor are formed on the surface of a substrate 2a formed of n-type semiconductor, whereby the first X-ray detection unit 11 and the second X-ray detection unit 21 are formed integrally with each other. The strips 12, 22 may be formed of n⁺-type semiconductor (see pages 27 to 28 of Document 5).

In the X-ray detector 2 described above, each of the strips 12 and 22 functions as a semiconductor detector. The first X-ray detection unit 11 functions as a one-dimensional position sensitive type detector which can discriminate the detection position in the X-direction, and the second X-ray detection unit 21 functions as a one-dimensional position sensitive type detector which can discriminate the detection position in the Y-direction.

As described above, this embodiment is configured so that the first X-ray detection unit 11 and the second X-ray detection unit 21 are formed integrally with each other on the substrate 2a formed of n-type semiconductor, for example.

### [Summary of X-Ray Diffraction Device and Measurement Method]

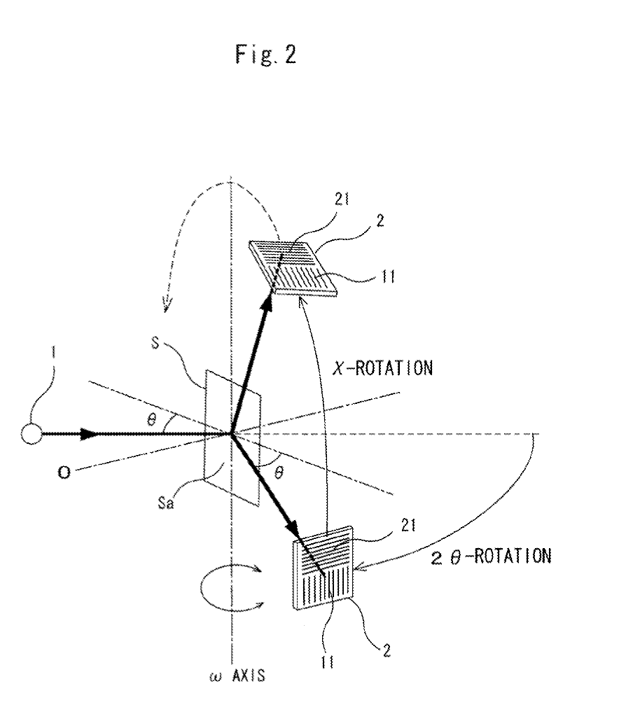

Next, an X-ray diffraction device according to an embodiment of the present invention will be described with reference to FIG. 2.

The X-ray diffraction device according to this embodiment has a construction that can perform both of X-ray diffraction measurement based on 2θ-rotation and in-plane diffraction measurement. That is, this X-ray diffraction device has a sample table (not shown), an X-ray source 1 for irradiating the surface Sa of a sample S with X-ray, an X-ray detector 2 for detecting X-ray diffracted from the sample S, and a goniometer (not shown). The sample S is held in a sample holder of the sample table. The goniometer has a θ-rotation mechanism 3 for mounting the sample table therein and subjecting the sample 5 to θ-rotation around a ω axial line passing on the sample surface Sa, and a 2θ-rotation mechanism 4 for mounting the X-ray detector 2 through an in-plane rotation mechanism 5 described later and subjecting the X-ray detector 2 to 2θ-rotation around the ω axial line. The in-plane rotation mechanism 5 is mounted in the 2θ-rotation mechanism 4, and subjects the X-ray detector 2 to χ-rotation around an axial line O orthogonal to the ω axial line, whereby the X-ray detector 2 can perform scanning measurements based on 2θ-rotation and χ-rotation on the sample surface Sa.

The publicly known constructions disclosed in the Document 2 and the Document 3 described above may be applied as the device construction described above.

As shown in FIG. 1, the X-ray detector 2 has the first X-ray detection unit 11 in which the plural strips 12 are arranged in parallel to one another in the X-direction (first direction), and the second X-ray detection unit 21 in which the plural strips 22 are arranged in parallel to one another in the Y-direction (second direction).

As shown in FIG. 1, the X-ray detector 2 is mounted in the X-ray diffraction device so that the X-direction (first direction) along which the strips 12 of the first X-ray detection unit 11 are arranged in parallel to one another is matched (coincident) with the tangential direction of 2θ-rotation and also the Y-direction (second direction) along which the strips 22 of the second X-ray detection unit 21 are arranged in parallel to one another is matched (coincident) with the tangential direction of χ-rotation.

In the X-ray diffraction device described above, the first X-ray detection unit 11 of the X-ray detector 2 is used for X-ray diffraction measurement based on 2θ-rotation, and the second X-ray detection unit 21 of the X-ray detector 2 is used for in-plane diffraction measurement based on scan in a χ-rotation direction.

Here, the first X-ray detection unit 11 functions as a one-dimensional position sensitive type detector which can discriminate (identify) the detection position in the X-direction (first direction) while each strip 12 functions as a detector, and thus the first X-ray detection unit 11 is particularly suitable for X-ray diffraction measurement based on a scanning operation in the 2θ-rotation direction called as a TDI (Time Delay Integration) mode.

The second X-ray detection unit 21 functions as a one-dimensional position sensitive type detector which can discriminate (identify) the detection position in the Y-direction (second direction) while each strip 22 functions as a detector, and thus the second X-ray detection unit 21 is particularly suitable for in-plane diffraction measurement based on the TDI (Time Delay Integration) mode.

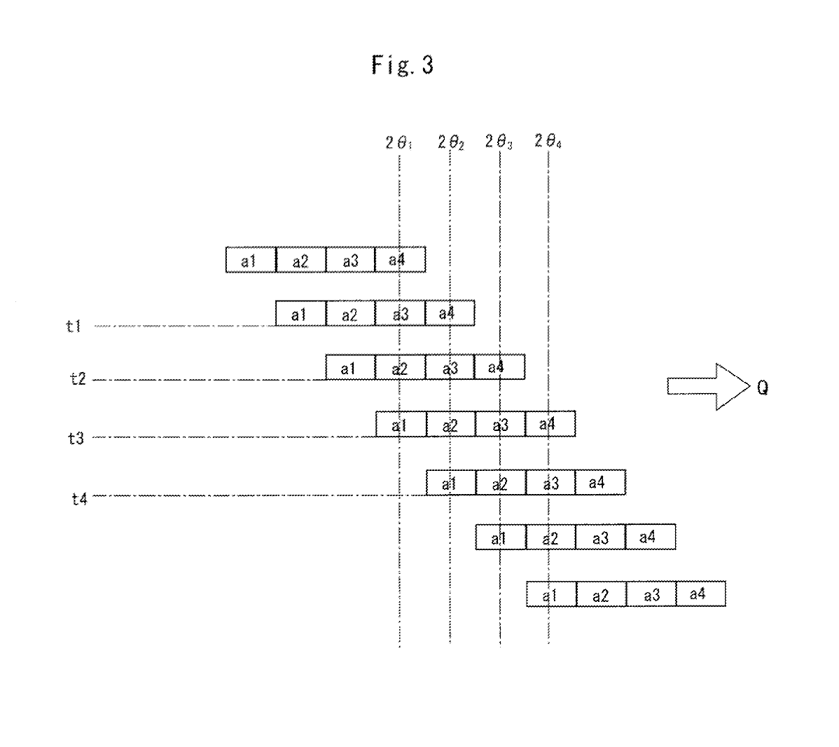

In the TDI mode, plural detectors a1, a2, a3, a4 (corresponding to the plural strips 12, 22) arranged in parallel are scanned in a parallel arrangement direction (the direction of Q of FIG. 3) as shown in FIG. 3 to read out detection data from each of the detectors a1, a2, a3, a4 at a timing t1, t2, t3, t4 which corresponds to a movement timing of one detector. The detection data of the respective detectors a1, a2, a3, a4 are summed up every scan angle 2θ₁, 2θ₂, 2θ₃, 2θ₄, and the X-ray intensity at each scan angle 2θ₁, 2θ₂, 2θ₃, 2θ₄ is determined.

The measurement based on the TDI mode has an advantage that the measurement speed increases and a large detection intensity can be obtained at each scan angle. The measurement principle based on the TDI mode has been publicly known, and it is described in detail in the Document 1, for example.

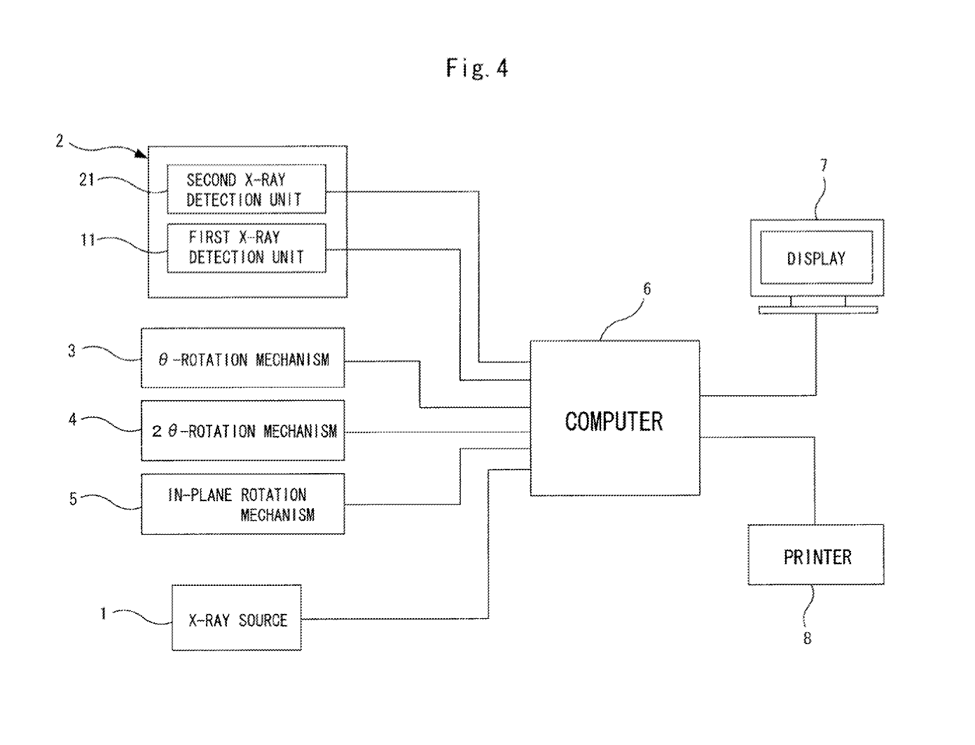

FIG. 4 is a block diagram showing a control/processing system of the X-ray diffraction device.

The X-ray diffraction device has a computer 6. The computer 6 operates on the basis of a dedicated program preinstalled therein. The computer 6 controls the respective constituent elements such as the X-ray source 1, the X-ray detector 2, the O-rotation mechanism 3, the 2θ-rotation mechanism 4, the in-plane rotation mechanism 5, etc. Furthermore, the computer 6 also functions as a data processing unit for processing detection data output from the first X-ray detection unit 11 and the second X-ray detection unit 21 of the X-ray detector 2. The processed data (measurement result) is stored into a storage unit in the computer 6, and output to external output devices such as a display 7, a printer 8, etc.

Here, the computer 6 also functions as a selecting and operating unit for selecting anyone of the first X-ray detection unit 11 and the second X-ray detection unit 21 and operating the selected X-ray detection unit. That is, the computer 6 automatically selects and operates any one of the first X-ray detection unit 11 and the second X-ray detection unit 21 which is selected as a data processing target. Accordingly, the detection data are automatically transmitted from only one of the X-ray detection units 11 and 21.

Specifically, the computer 6 selects one of the respective measurement modes for the X-ray diffraction measurement based on 2θ-rotation and the in-plane diffraction measurement on the basis of an instruction from the external, selects one of the first X-ray detection unit 11 and the second X-ray detection unit 21 in accordance with the selected measurement mode and starts the measurement. Furthermore, the computer 6 processes detection data taken from the selected X-ray detection unit 11 or 21.

The computer 6 also has functions as an origin matching unit and an origin correcting unit described later.

### [Origin Matching Unit and Origin Correcting Unit]

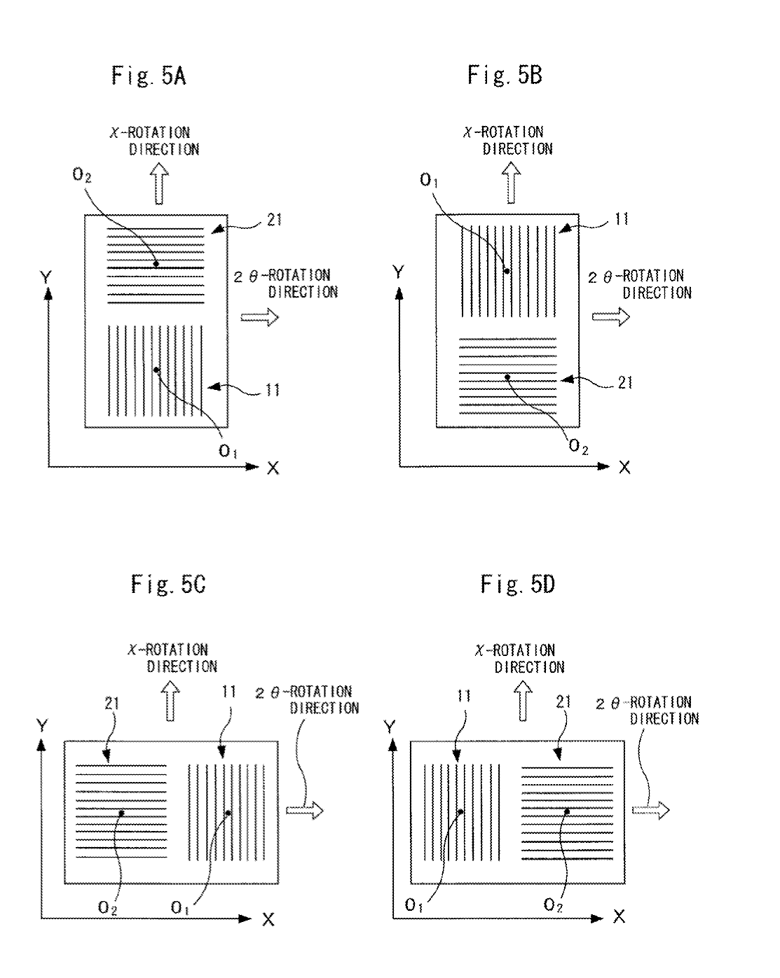

As shown in FIGS. 5A to 5D, in the X-ray detector 2 described above, the center O₁ (measurement reference position) of the first X-ray detection unit 11 is not coincident with the center O₂ (measurement reference position) of the second X-ray detection unit 21. For example, in the construction shown in FIGS. 5A and 5B, the respective centers O and O₂ of the X-ray detection units 11 and 21 are away from each other in the Y-direction (second direction). Furthermore, in the construction shown in FIGS. 5C and 5D, the respective centers O and O₂ of the X-ray detection units 11, 21 are away from each other in the X-direction (first direction).

Therefore, in the X-ray diffraction device according to this embodiment, the center O of the first X-ray detection unit 11 and the center O₂ of the second X-ray detection unit 21 are known in advance, and a control system for the X-ray diffraction device is incorporated with an origin matching unit for matching (making coincident) the center O of the first X-ray detection unit 11 and the center O₂ of the second X-ray detection unit 21 with the measurement origin for 2θ-rotation under the X-ray diffraction measurement based on 2θ-rotation and the measurement origin for χ-rotation under the in-plane diffraction measurement respectively on the basis of the predetermined the center O of the first X-ray detection unit 11 and the center O₂ of the second X-ray detection unit 21. The measurement origin is set as follows. For example, the X-ray source 1 and the X-ray detector 2 are disposed to face each other, and X-ray is directly applied (irradiated) from the X-ray source 1 to the X-ray detector 2. At this time, the center position of an irradiation area of the X-ray detector 2 is defined as the measurement origin.

Furthermore, the origin matching unit may be configured to match only the center O₁ of the first X-ray detection unit 11 with the measurement origin for 2θ-rotation, and the control system may be incorporated with not only the origin matching unit, but also an origin correcting unit for correcting a displacement (deviation) between the measurement origin for the χ-rotation and the center O₂ of the second X-ray detection unit 21 which occurs under the state that the center O₁ of the first X-ray detection unit 11 is matched with the measurement origin for 2θ-rotation when the in-plane diffraction measurement is performed.

The origin matching unit may be configured to match only the center O₂ of the second X-ray detection unit 21 with the measurement origin for χ-rotation, and the origin correcting unit may be configured to correct a displacement (deviation) between the measurement origin for the 2θ-rotation and the center O₁ of the first X-ray detection unit 11 which occurs under the state that the center O₂ of the second X-ray detection unit 21 is matched with the measurement origin for χ-rotation when the X-ray diffraction measurement based on the 2θ-rotation is performed.

The origin matching unit and the origin correcting unit are constructed by the computer 6, and the center O₁ (measurement reference position) of the first X-ray detection unit 11 and the center O₂ (measurement reference position) of the second X-ray detection unit 21 are recorded in the computer 6 in advance.

### [Pseudo Two-Dimensional Measurement]

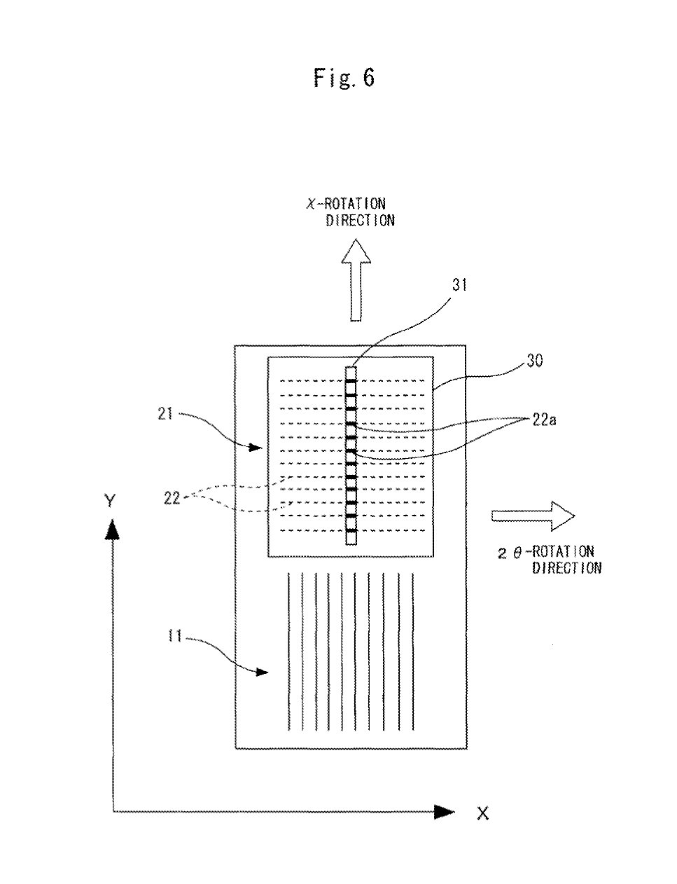

FIG. 6 shows a construction for performing pseudo two-dimensional measurement by the X-ray diffraction device according to the embodiment.

That is, a linear slit 31 is formed in a flat-plate type shield cover 30 having an X-ray shielding function, and the shield cover 30 is mounted on the detection face of the second X-ray detection unit 21 while the slit 31 (i.e., the longitudinal direction of slit 31) is matched with the Y-direction (second direction).

Accordingly, the plural strips 22 of the second X-ray detection unit 21 are converted to spot-shaped measurement areas 22a corresponding to only an area of the detection face which confronts the slit 31. These spot-shaped measurement areas are arranged in parallel to one another in the Y-direction (second direction).

In the pseudo two-dimensional measurement, the X-ray diffraction measurement based on 2θ-rotation is performed by using the second X-ray detection unit 21 covered with the shield cover 30. That is, X-ray data detected at each of the measurement areas 22a is accumulated in association with the position of the slit 31 at the detection time point while the X-ray detector 2 is scanned (2θ-scanned) in the direction (2θ-rotation direction) perpendicular to the Y-direction, whereby two-dimensional X-ray diffraction data based on coordinate axes corresponding to two directions (Y-direction and the 2θ-rotation direction perpendicular to the Y-direction) can be obtained.

### Other Embodiments

The present invention is not limited to the above embodiments, and various modifications or applications can be made to the above embodiments.

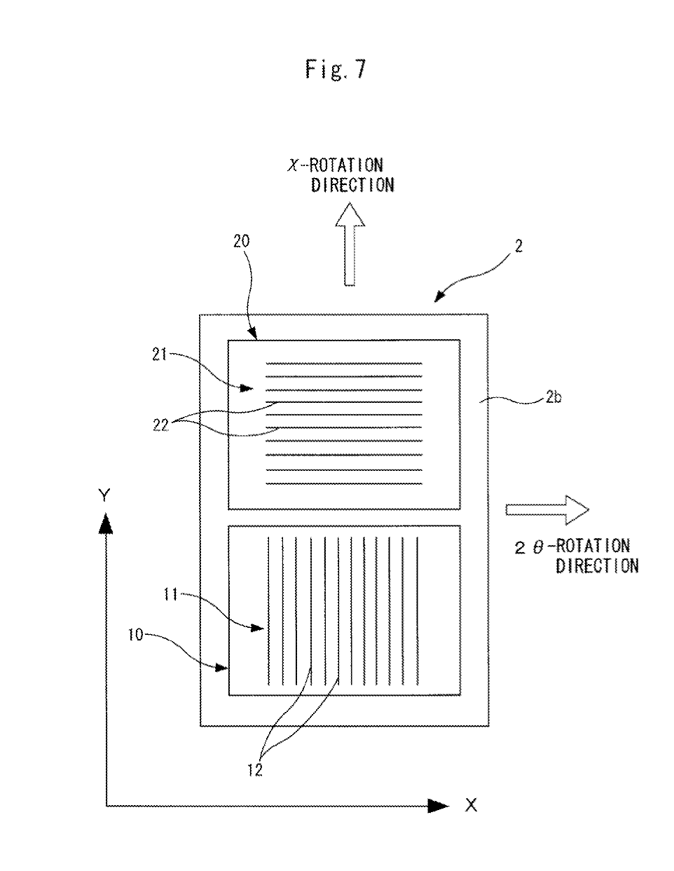

For example, the X-ray detector 2 may be configured so that two silicon strip detectors 10, 20 (element X-ray detectors) are arranged side by side on the surface of a substrate 2b as shown in FIG. 7. Plural strips 12, 22 forming slender unit measurement areas are arranged side by side on each of the detectors 10, 20. As in the case of the X-ray detector 2 as shown in FIG. 1, one detector 10 is disposed so that the plural strips 12 are arranged in parallel to one another (side by side) in the X-direction (first direction), and the other detector 20 is disposed so that the plural strips 22 are arranged in parallel to one another (side by side) in the Y-direction (second direction).

The same function as the X-ray detector 2 according to the embodiment described above can be also performed by the above construction.

1. An X-ray detector comprising a first X-ray detection unit having a plurality of slender unit measurement areas arranged in parallel to one another in a first direction, and a second X-ray detection unit having a plurality of slender unit measurement areas arranged in parallel to one another in a second direction orthogonal to the first direction.

2. An X-ray diffraction device comprising:
a θ-rotation mechanism that rotates a sample held in a sample holder around an ω axial line passing on the surface of the sample;
an X-ray source that irradiates the surface of the sample with X-ray;
the X-ray detector according to claim 1 that detects X-ray diffracted from the sample;
a 2θ-rotation mechanism that subjects the X-ray detector to 2θ-rotation around the ω axial line; and
an in-plane rotation mechanism that subjects the X-ray detector to χ-rotation around an axial line orthogonal to the ω axial line, wherein the first direction along which the slender unit measurement areas of the first X-ray detection unit are arranged in parallel to one another is matched with a tangential direction of the 2θ-rotation, and the second direction along which the slender unit measurement areas of the second X-ray detection unit are arranged in parallel to one another is matched with a tangential direction of the χ-rotation.

3. The X-ray diffraction device according to claim 2, further comprising a selecting and operating unit that selects and operates one of the first X-ray detection unit and the second X-ray detection unit.

4. The X-ray diffraction device according to claim 3, further comprising a data processing unit that processes detection data output from any one of the first X-ray detection unit and the second X-ray detection unit, wherein the selecting and operating unit automatically selects and operates one of the first X-ray detection unit and the second X-ray detection unit whose detection data is selected as a data processing target by the data processing unit.

5. The X-ray diffraction device according to claim 2, further comprising an origin matching unit that matches a predetermined X-ray measurement reference position of the first X-ray detection unit with a measurement origin for the 2θ-rotation and matches a predetermined X-ray measurement reference position of the second X-ray detection unit with a measurement origin for the χ-rotation on the basis of the predetermined X-ray measurement reference position of the first X-ray detection unit and the predetermined X-ray measurement reference position of the second X-ray detection unit.

6. The X-ray diffraction device according to claim 2, further comprising an origin matching unit that matches a predetermined X-ray measurement reference position of the first X-ray detection unit with a measurement origin for the 2θ-rotation on the basis of the predetermined X-ray measurement reference position of the first X-ray detection unit, and an origin correcting unit that corrects a displacement between a predetermined X-ray measurement reference position of the second X-ray detection unit and a measurement origin for the χ-rotation on the basis of the predetermined X-ray measurement reference position of the second X-ray detection unit, the displacement occurring under a state that the X-ray measurement reference position of the first X-ray detection unit is matched with the measurement origin for the 2θ-rotation.

7. The X-ray diffraction device according to claim 2, further comprising an origin matching unit that matches a predetermined X-ray measurement reference position of the second X-ray detection unit with a measurement origin for χ-rotation on the basis of the predetermined X-ray measurement reference position of the second X-ray detection unit, and an origin correcting unit that corrects a displacement between a predetermined X-ray measurement reference position of the first X-ray detection unit and a measurement origin for the 2θ-rotation on the basis of the predetermined X-ray measurement reference position of the first X-ray detection unit, the displacement occurring under a state that the X-ray measurement reference position of the second X-ray detection unit is matched with the measurement origin for the χ-rotation.

8. The X-ray diffraction device according to claim 2, wherein the first X-ray detection unit and the second X-ray detection unit are formed integrally with each other on the same substrate.

9. The X-ray diffraction device according to claim 2, wherein two element X-ray detectors each having a plurality of slender unit measurement areas arranged in parallel to one another are arranged on the same substrate, the plurality of slender unit measurement areas of one of the element X-ray detectors are arranged in the first direction to constitute the first X-ray detection unit, and the plurality of slender unit measurement areas of the other element X-ray detector are arranged in the second direction to constitute the second X-ray detection unit.

10. The X-ray diffraction device according to claim 2, wherein the X-ray detector comprises a silicon strip detector in which strips formed of semiconductor form the slender unit measurement areas.

11. The X-ray diffraction device according to claim 2, further comprising a flat-plate type shield cover that has an X-ray shielding function and is provided with a linear slit formed therein, wherein the shield cover is mounted on a detection face of the second X-ray detection unit while a longitudinal direction of the slit is matched with the second direction.

12. The X-ray diffraction device according to claim 5, wherein the origin matching unit comprises a computer, the X-ray measurement reference position of the first X-ray detection unit and the X-ray measurement reference position of the second X-ray detection unit are pre-stored in the computer, and on the basis of the pre-stored X-ray measurement reference positions of the first X-ray detection unit and the second X-ray detection unit, the computer executes calculation processing to match the X-ray measurement reference position of the first X-ray detection unit with the measurement origin for 2θ-rotation and match the X-ray measurement reference position of the second X-ray detection unit with the measurement origin for χ-rotation.

13. The X-ray diffraction device according to claim 6, wherein the origin matching unit and the origin correcting unit comprise a computer, the X-ray measurement reference position of the first X-ray detection unit and the X-ray measurement reference position of the second X-ray detection unit are pre-stored in the computer, and on the basis of the pre-stored X-ray measurement reference positions of the first X-ray detection unit and the second X-ray detection unit, the computer executes calculation processing to match the X-ray measurement reference position of the first X-ray detection unit with the measurement origin for 2θ-rotation, and executes calculation processing to correct the displacement between the X-ray measurement reference position of the second X-ray detection unit and the measurement origin for χ-rotation which occurs under the state that the X-ray measurement reference position of the first X-ray detection unit is matched with the measurement origin for 2θ-rotation.

14. The X-ray diffraction device according to claim 7, wherein the origin matching unit and the origin correcting unit comprise a computer, the X-ray measurement reference position of the first X-ray detection unit and the X-ray measurement reference position of the second X-ray detection unit are pre-stored in the computer, and on the basis of the pre-stored X-ray measurement reference positions of the first X-ray detection unit and the second X-ray detection unit, the computer executes calculation processing to match the X-ray measurement reference position of the second X-ray detection unit with the measurement origin for χ-rotation, and executes calculation processing to correct the displacement between the X-ray measurement reference position of the first X-ray detection unit and the measurement origin for 2θ-rotation which occurs under the state that the X-ray measurement reference position of the second X-ray detection unit is matched with the measurement origin for χ-rotation.
